(19) United States
(12) Patent Application Publication
(10) Pub. No.: US 2014/0196591 A1
(43) Pub. Date: Jul. 17, 2014

(54) Method and Device for Protection of Musical Instruments

(71) Applicant: Kyle James Comino, Millersburg, IN (US)

(72) Inventor: Kyle James Comino, Millersburg, IN (US)

(21) Appl. No.: 14/153,004

(22) Filed: Jan. 11, 2014

Related U.S. Application Data
(60) Provisional application No. 61/848,853, filed on Jan. 14, 2013.

(51) Int. Cl. G10G 7/00

(52) U.S. Cl. CPC G10G 7/00
USPC 84/453

(57) ABSTRACT

Musical instrument protection devices are provided based a removable impact absorbing ring that shields the bell of a musical instrument. A continuous offset slit in the ring receives the bell of an instrument while minimally intruding on the sound of the instrument. The absorbing ring pads and shields the bell of the instrument. Tubing of the instrument is protected with removable pieces from a resilient material which are held on with clip features. The clip features tightly fit around the circumference of the instrument's tubing. The padding provides protection from impact damage on commonly susceptible areas.

### BACKGROUND, OBJECTIVES, AND SUMMARY OF THE INVENTION

The present invention relates generally to a device that is used to protect commonly exposed and vulnerable areas of musical instruments.

There are few devices that protect musical instruments, namely hard shell and soft sided cases. These are limited to cases and padded straps. These devices only protect the instrument in transit and storage and are limited by protecting the instrument while it is not in use.

There have been a wide range of devices or functional elements used for these purposes, perhaps the simplest example being a tube slit through the middle that fits over the bell of the instrument.

However, the effectiveness of these devices can significantly alter the sound of the instrument in an unintended or undesirable manner.

Many times, the owner of the instrument is left to accept the inevitable damage that happens during regular use. For example, marching bands are required to frequently handle and move their instruments, inviting damage. Frequently, marching bands are rushed on and off the field during a break in a rehearsal or contest, where the band members frequently run to their respective places. All of this leaves the opportunity for collision or dropping of the instrument along with damage from setting the instrument down. Without protection, the user is frequently left with an instrument that cost a lot of money, but has lost a significant amount of value due to dings, dents, and scratches. Few alternative solutions are available. These include the use of a towel to act as a barrier between the instrument and the ground.

In some cases, the user uses tape to cover parts of the instrument and/or commonly available hose that has been slit to receive the instrument's tubing.

While the prior art solves many related problems, none exist that are both easy to remove and install while protecting common vulnerable areas of the instrument. Accordingly, it is an objective of the present invention to significantly reduce the amount and type of damage to musical instruments. Other objectives include:
a. relatively inexpensive to mass produce,
b. adaptable to a wide range of musical instrument sizes and types,
c. reliable over an extended period of use and varying environmental conditions,
d. easily attached to the instrument,
e. minimally alters the sound of the instrument,
f. does not damage or require modification of the instrument,
g. non-intrusive to the user,
h. water, shock, and abuse resistant; and
i. compact and capable of lightweight construction.

These and other objectives of the present invention are obtained by the features and materials of the protection pieces.

The bell of the instrument is encircled by an impact absorbing ring of material, held on by particular interior features and tension of said ring around the bell. The absorbing ring can be sized to fit various musical instruments.

Additionally, another protection device can be affixed to the tubing of the instrument and snaps into place around the diameter of the musical instrument's tube using the clip feature. The embodiment shown is J shaped but is not limited to this. For the purposes of clarity, this piece will be hereinafter referred to the J-pad. The J-pad can be shaped to fit the contour of the particular instrument's tubing. For example, a French horn is more circular in nature, making the J-pad more “C” shaped instead of J shaped. For a trombone, the J-pad could have more equal lengths of the clip features, making it more shaped like a “U”. The protection offered by this is from the outside facing arc of material that snugly fits the tube of the instrument. Clip features are shown at the ends of the “J” but can also be disposed along the length based on the size, shape, and area of the particular musical instrument. Each clip feature has two parallel extensions that serve as a lead-in to make installation to the instrument easier. The resilient nature of the material and the geometry of the clip features keep the J-pad in place during storage, transportation, and use of the instrument.

Other objectives, advantages, and novel features of the present invention will become readily apparent to those skilled in the relevant art from the following drawings and description of preferred embodiments.

### BRIEF DESCRIPTION OF THE DRAWINGS

FIG. 1 shows a cross section showing the slit that receives the bell of the instrument.

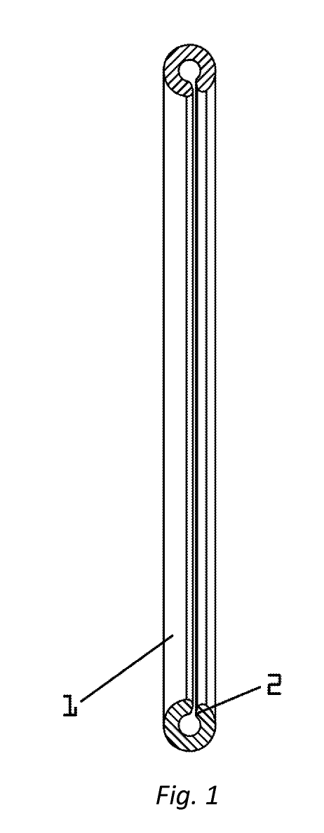

FIG. 2 shows the entire protective ring.

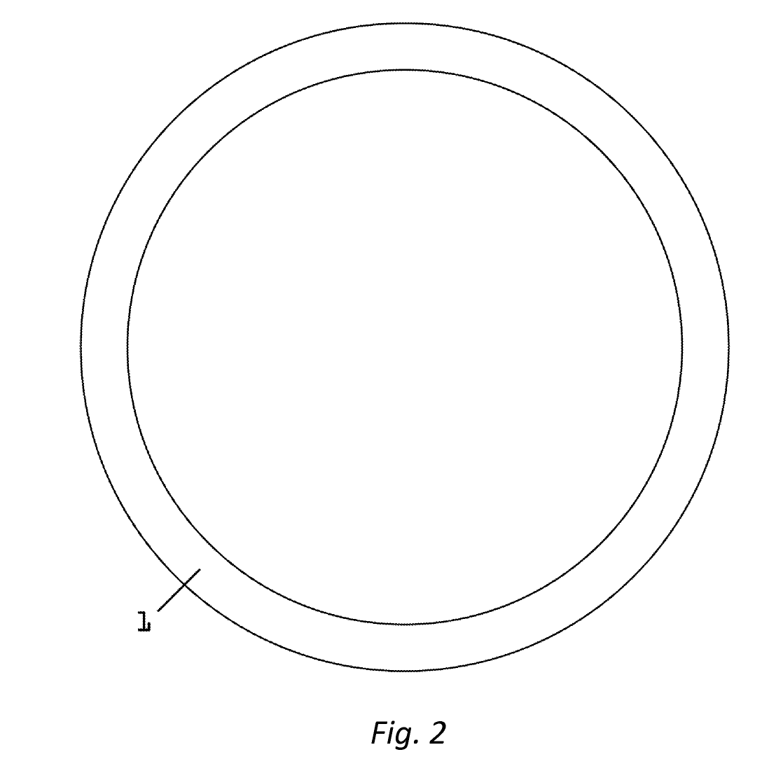

FIG. 3 shows an enlarged cross section of the protective ring as it is installed on a musical instrument.

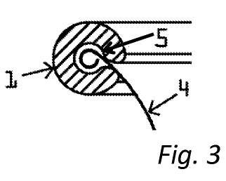

FIG. 4 shows a cross section of the protective ring.

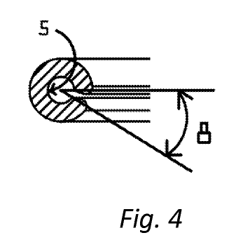

FIG. 5 shows another angle of the j-pad with the clip feature that is used to hold it in place.

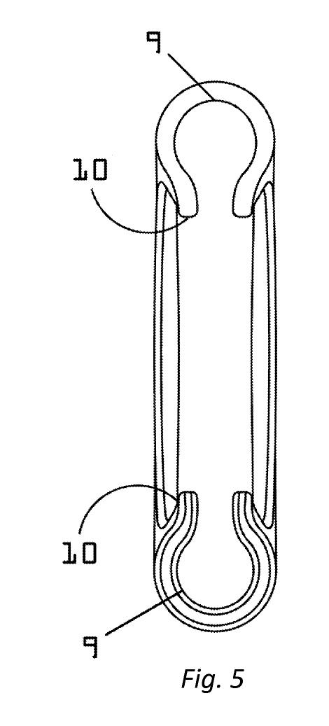

FIG. 6 shows a cross section of the j-pad as it is installed on the instrument.

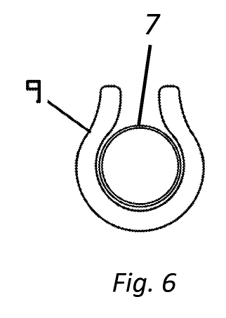

FIG. 7 shows a cross section of the J-pad

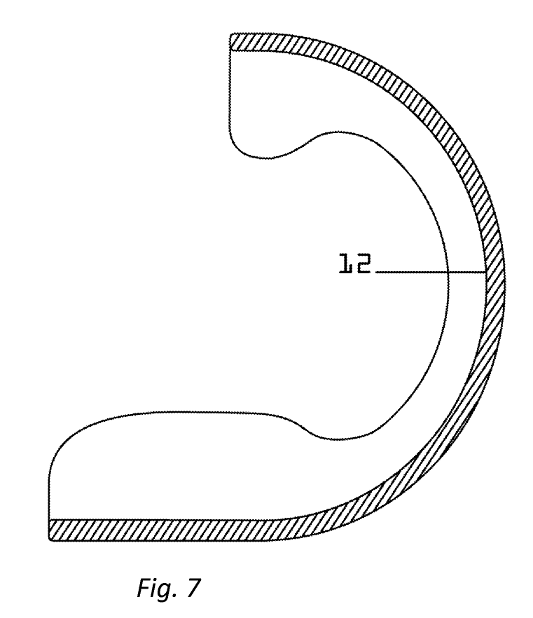

FIG. 8 shows a side view of the J-pad

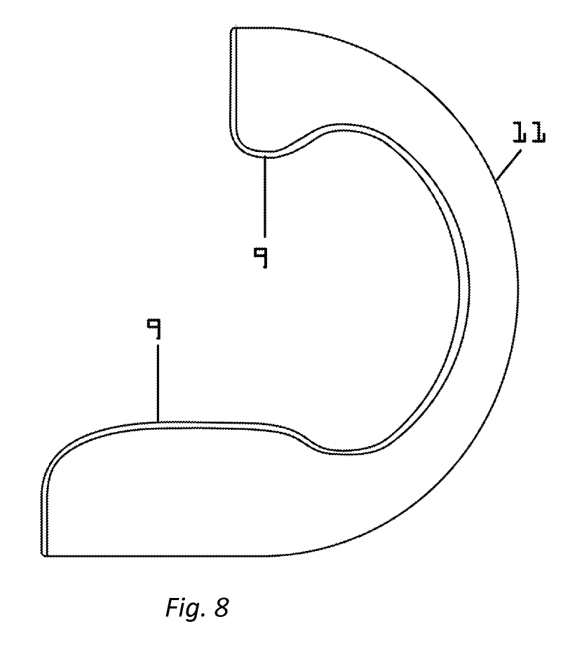

### DETAILED DESCRIPTION OF PREFERRED EMBODIMENTS

The protective ring 1 has a mostly circular cross section with an interior cavity 5 that is also circular. The cross section is split 2 away from the inside radius of the ring. This split is made in order to receive the bell of a musical instrument 4 and is offset 8 in order to match the natural angle of the bell as it enters the split ring. This offset minimizes the impact on the instrument's sound, as any obstruction in the path of sound can color it undesirably.

The J-pad 11 is an impact absorbing shield that is made up of clip features 9 that maintain pressure on the instrument's tubular section. These clip features have a lead-in 10 to allow easy installation onto the musical instrument. The clip feature's diameter is slightly smaller than the outside diameter of the instrument's tubing 7 and is held in place by surrounding the instrument by more than 180°. Between the clip features, a band of resilient material 12 protects the outermost part of the instrument's tubing.

Although the present invention has been described in detail with respect to a particular embodiment, this has been by way of illustrative example only. The present invention may be modified as needed to particular embodiments which are not illustrated herein. Accordingly, the spirit and scope of the present invention are limited only by the following claims.

What is claimed is:

1. A shock absorbing annular ring made from stretchable material that is partially split such that the diameter of said split is smaller than the bell of the instrument, wherein said ring is held onto the perimeter of the bell of the instrument by the tension of said ring's interior features and axially by the split, wherein said split is offset from the center of the ring to reduce the impact of said ring on the sound of the instrument.

2. The ring according to claim 1, wherein said ring is made from a continuous tube, and the split in said tube is offset by at least 10 degrees from the tangent point of the center of said ring.

3. The ring according to claim 1, wherein said ring is non-circular.

4. A shock absorbing sleeve, curved to match the outside features of an instrument's tube, partially disposed about the outside features of said tube, and retained with clip features along the axis of said sleeve that are circumferentially disposed about said tube greater than 180 degrees.

5. The sleeve according to claim 4, wherein said clip features are near the ends of said sleeve.
